(19) United States
(12) Patent Application Publication
(10) Pub. No.: US 2013/0236183 A1
(43) Pub. Date: Sep. 12, 2013

(54) VISIBLE LIGHT COMMUNICATION TRANSCEIVER AND SYSTEM

(71) Applicants: Chia-Hsin Chao, Taichung City (TW); Wen-Yung Yeh, Hsinchu County (TW); Hung-Pin Yang, Hsinchu City (TW)

(72) Inventors: Chia-Hsin Chao, Taichung City (TW); Wen-Yung Yeh, Hsinchu County (TW); Hung-Pin Yang, Hsinchu City (TW)

(73) Assignee: INDUSTRIAL TECHNOLOGY RESEARCH INSTITUTE, Hsinchu (TW)

(21) Appl. No.: 13/445,916

(22) Filed: Apr. 13, 2012

(30) Foreign Application Priority Data
Mar. 6, 2012 (TW) 101107501

(51) Int. Cl. H04B 10/24; H04J 14/08

(52) U.S. Cl. 398/101; 398/135

(57) ABSTRACT

A visible light communication (VLC) transceiver and a VLC system are provided. The VLC transceiver includes a substrate, a lens module and a plurality of channel units. The channel units are disposed on the substrate in an array to provide different bidirectional communication channels. Wherein, each of the channel units respectively includes at least a visible light emitter and at least a visible light receiver. The channel units can enhance communication bandwidth by using modulation technology such as spatial multiplexing or time multiplexing. The lens module is disposed on an optical path of the channel units. The lens module actively tracks the receiving situation of the visible light receiver to improve the signal quality of high-speed multiplexing communication.

### CROSS-REFERENCE TO RELATED APPLICATION

This application claims the priority benefit of Taiwan application serial no. 101107501, filed on Mar. 6, 2012. The entirety of the above-mentioned patent application is hereby incorporated by reference herein and made a part of this specification.

### BACKGROUND

1. Technical Field

The technical field relates to a visible light communication transceiver and a visible light communication system.

2. Background

Along with increasing popularity of light-emitting diode (LED) lighting, a high-speed modulation characteristic of the LED results in a fact that application potential of the LED in visible light communications (VLC) has drawn widespread attentions. A conventional VLC system can only provide about a Kb/s level unidirectional (or downstream) transmission communication.

The VLC system has advantages of short transmission distance, smaller cell coverage range, information security, no EMI interference, no need of a frequency band usage license, and suitable for providing indoor lighting, etc. Therefore, how to provide a bidirectional and high-speed (for example, greater than 100 Mb/s) VLC system is a particularly urgent research topic.

### SUMMARY

One of exemplary embodiments of the disclosure provides a visible light communication (VLC) transceiver including a substrate, a lens module and a plurality of channel units. The lens module is disposed on an optical path of the channel units. The channel units are disposed on the substrate in an array. The channel units respectively provide different bidirectional communication channels, where each of the channel units respectively includes at least one visible light emitter and at least one visible light receiver.

One of exemplary embodiments of the disclosure further provides a visible light communication (VLC) transceiver including a downstream channel array, a lens module, a lens actuation module and a controller. The downstream channel array includes a plurality of downstream channel units configured to respectively provide different downstream channels, where each of the downstream channel units includes at least one visible light receiver. The lens module is disposed on an optical path of the downstream channel array. The lens actuation module is coupled to the lens module. The controller is coupled to the downstream channel units and the lens actuation module. The controller controls the lens actuation module to adjust a position, an optical axis direction or a focal length of the lens module according to receiving situations of the visible light receivers.

One of exemplary embodiments of the disclosure provides a visible light communication (VLC) system including a first VLC transceiver and a second VLC transceiver. The first VLC transceiver includes at least one upstream channel unit. The upstream channel unit includes at least one visible light emitter. The second VLC transceiver includes a downstream channel array, a lens module, a lens actuation module and a controller. The downstream channel array includes a plurality of downstream channel units configured to respectively provide different downstream channels, where each of the downstream channel units includes at least one visible light receiver. At least one downstream channel unit receives a visible light emitted by the first VLC transceiver. The lens module is disposed on an optical path of the downstream channel units. The lens actuation module is coupled to the lens module. The controller is coupled to the downstream channel unit and the lens actuation module. The controller controls the lens actuation module to adjust a position, an optical axis direction or a focal length of the lens module according to receiving situations of the visible light receivers.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a functional block schematic diagram of a visible light communication (VLC) system according to an exemplary embodiment of the disclosure.

FIG. 2 is an application schematic diagram of a VLC system according to another exemplary embodiment of the disclosure.

FIG. 3 is a layout schematic diagram of a VLC chip of FIG. 1 according to an exemplary embodiment of the disclosure.

FIG. 4 is a layout schematic diagram of replacing large-die LEDs with micro LEDs according to another exemplary embodiment of the disclosure.

FIG. 5 is a schematic diagram of integrating an upstream channel array and a downstream channel array of the VLC chip 221 into a bi-directional channel array.

FIG. 6 is a circuit diagram of a bi-directional channel array of the VLC chip of FIG. 3 according to an exemplary embodiment of the disclosure.

FIG. 7 is a circuit diagram of a channel unit of FIG. 6 according to an exemplary embodiment of the disclosure.

FIG. 8 and FIG. 9 are functional block schematic diagrams of a lens actuation module of FIG. 1 according to an exemplary embodiment of the disclosure.

FIG. 10 is an application schematic diagram of the VLC system of FIG. 1 or FIG. 2 actively tracking visible light signals according to still another exemplary embodiment of the disclosure.

FIG. 11 is a circuit diagram of a channel unit of FIG. 3 according to another exemplary embodiment of the disclosure.

FIG. 12 is a circuit diagram of a channel unit of FIG. 3 according to still another exemplary embodiment of the disclosure.

FIG. 13 is a circuit diagram of a channel unit of FIG. 3 according to still another exemplary embodiment of the disclosure.

### DETAILED DESCRIPTION OF DISCLOSED EMBODIMENTS

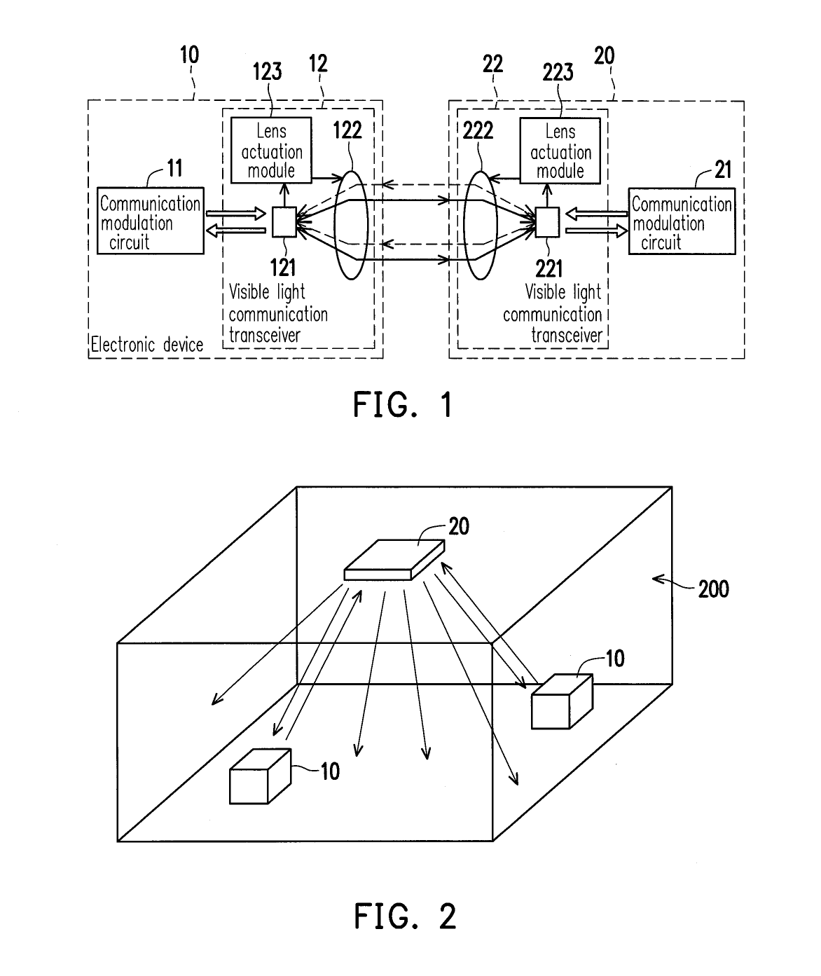

FIG. 1 is a functional block schematic diagram of a visible light communication (VLC) system according to an exemplary embodiment of the disclosure.

The VLC system includes at least one first electronic device 10 and a second electronic device 20. The first electronic device 10 at least includes a communication modulation circuit 11 and a first VLC transceiver 12, and the second electronic device 20 at least includes a communication modulation circuit 21 and a second VLC transceiver 22. The communication modulation circuit 11 converts transmission data into a VLC signal through the first VLC transceiver 12, and the first VLC transceiver 12 transmits the VLC signal to the second VLC transceiver 22 of the second electronic device 20 through a communication channel. According to an actual product design requirement, the communication channel between the first VLC transceiver 12 and the second VLC transceiver 22 can be a closed channel (for example, fiber) or an open channel.

The second VLC transceiver 22 can convert the VLC signal of the first VLC transceiver 12 into an electric signal, and then outputs the electric signal to the communication modulation circuit 21. The communication modulation circuit 21 of the second electronic device 20 can demodulate the electric signal to obtain transmission data from the first electronic device 10.

According to the actual product design requirement, the communication channel between the first VLC transceiver 12 and the second VLC transceiver 22 can be a unidirectional communication channel or a bi-directional communication channel. Here, it is assumed that the communication channel between the first VLC transceiver 12 and the second VLC transceiver 22 is a unidirectional communication channel. The first VLC transceiver 12 includes a VLC chip 121, a lens module 122 and a lens actuation module 123. The VLC chip 121 has at least one upstream channel unit for providing at least one upstream channel, where the upstream channel unit includes at least one visible light emitter. According to the actual product design requirement, the visible light emitter includes a light-emitting diode (LED), a light emitter or other visible light-emitting devices.

The lens actuation module 123 is coupled to the lens module 122. The lens module 122 is disposed on an optical path of the VLC chip 121. The lens actuation module 123 can adjust a position, an optical axis direction or a focal length of the lens module 122. The visible light emitter of the VLC chip 121 is driven by the communication modulation circuit 11 to emit the VLC signal. The VLC signal is transmitted to the second VLC transceiver 22 through the lens module 122.

The second VLC transceiver 22 includes a VLC chip 221, a lens module 222 and a lens actuation module 223. The VLC chip 221 has a downstream channel array, where the downstream channel array includes a plurality of downstream channel units configured to respectively provide different downstream channels (input channels), and each of the downstream channel units respectively includes a visible light receiver. The visible light receivers include photodiodes, photon detectors or other visible light sensing elements. The VLC signal of the first VLC transceiver 12 is received by the VLC chip 221 through the lens module 222. The VLC chip 221 converts the VLC signal of the first VLC transceiver 12 into an electric signal, and outputs the electric signal to the communication modulation circuit 21. A detailed implementation of the VLC chip 221 is described later.

On the other hand, the lens actuation module 223 is coupled to the lens module 222 and the VLC chip 221. The lens actuation module 223 can actively control/adjust a position, an optical axis direction or a focal length of the lens module 222 according to receiving situations of the visible light receivers on the VLC chip 221. A method that the lens actuation module 223 (or 123) drives the lens module 222 (or 122) is determined according to the actual product design requirement. For example, the method that the lens actuation module 223 (or 123) drives the lens module 222 (or 122) can be similar to a driving method of an optical pickup head in an optical disk drive. For another example, the method that the lens actuation module 223 (or 123) drives the lens module 222 (or 122) can be similar to a driving method of a lens module in a digital camera.

In another embodiment, under permission of an application environment/design conditions, the above lens actuation module 223 (or 123) can be omitted, and the lens module 222 (or 122) is fixed to an optimal position on the optical path. In other embodiments, in consideration of the actual product design requirement, the lens actuation module 223 (or 123) and the lens module 222 (or 122) can be omitted.

In the aforementioned exemplary embodiment, the VLC system is assumed to have the unidirectional communication. However, the disclosure is not limited thereto. For example, the VLC chip 221 of the second VLC transceiver 22 further includes an upstream channel array, and the upstream channel array includes a plurality of second upstream channel units for respectively providing different upstream channels (output channels). Each of the second upstream channel units respectively includes at least one visible light emitter. The visible light emitter includes an LED, a light emitter or other visible light-emitting elements. The lens module 222 is further disposed on an optical path of the second upstream channel units of the VLC chip 221. Implementation of the first VLC transceiver 12 is similar to that of the second VLC transceiver 22, so that the VLC system of FIG. 1 can achieve the bi-directional communication.

FIG. 2 is an application schematic diagram of a VLC system according to another exemplary embodiment of the disclosure. Related descriptions of FIG. 1 can be referred for the description of the embodiment of FIG. 2. Referring to FIG. 1 and FIG. 2, different to the embodiment of FIG. 1, the VLC system of FIG. 2 is configured with a plurality of the first electronic devices 10. FIG. 2 illustrates a room 200, and two first electronic devices 10 and one second electronic device 20 are disposed in the room 200. The first electronic devices 10 can be smart TVs, personal computers, or other electronic devices. The second electronic device 20 can be an access point, a repeater, a router or other electronic device of a communication network. In this application example, the communication channel between the first electronic devices 10 and the second electronic device 20 can be an open channel. The VLC system has advantages of no EMI interference, no need of a frequency band usage license, and suitable for providing indoor lighting, etc. Therefore, the second electronic device 20 can be taken as a lighting device (an indoor lamp) of the room 200. Namely, the VLC signal emitted by the second electronic device 20 can simultaneously provide indoor lighting.

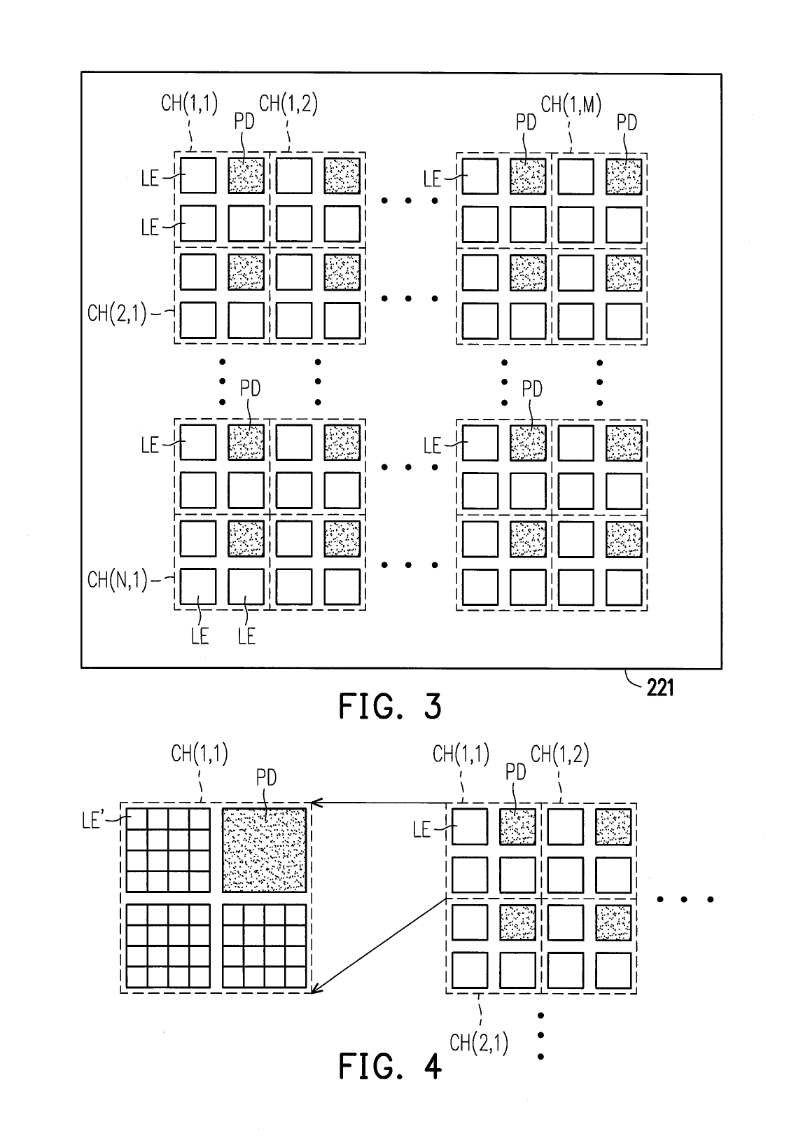

FIG. 3 is a layout schematic diagram of the VLC chip 221 of FIG. 1 according to an exemplary embodiment of the disclosure. In the present exemplary embodiment, the upstream channel array and the downstream channel array of the VLC chip 221 are integrated as a bi-directional channel array as that shown in FIG. 3. Referring to FIG. 3, the VLC chip 221 of the high-speed second VLC transceiver 22 includes a substrate and a plurality of channel units. The channel units are disposed on the substrate in an array. In the embodiment of FIG. 3, the VLC chip 221 has M*N channel units, for example, channel units CH(1,1), CH(1,2), CH(1,M), CH(2,1) and CH(N,1), etc. The lens module 222 shown in FIG. 1 is disposed on the optical path of the channel units. The channel units respectively provide different bi-directional communication channels, where each of the channel units includes at least one visible light emitter LE and at least one visible light receiver PD. In the embodiment of FIG. 3, each of the channel units includes three visible light emitters LE and one visible light receiver PD, though implementation of the disclosure is not limited thereto, and the number of the visible light emitters LE and the number of the visible light receivers PD can be determined according to the actual product design requirement.

The visible light emitters LE include LEDs or other visible light-emitting elements. The visible light emitters LE are used for visible light signal uplink. The visible light receivers PD include photodiodes, photon detectors or other visible light sensing elements. The visible light receivers PD are used for visible light signal downlink. In a same channel unit, for example, in the channel unit CH(1,1), the visible light emitters LE can be connected in series, in parallel and/or independently connected to the communication modulation circuit 21 according to a design requirement. Namely, according to the design requirement, the communication modulation circuit 21 can simultaneously light all of/a part of the visible light emitters LE in the same channel unit to increase luminous flux. Alternatively, the communication modulation circuit 21 can independently drive all of/a part of the visible light emitters LE in the same channel unit to increase signal modulation degree of freedom. For example, the channel units of the VLC chip 221 can enhance communication bandwidth by using modulation technology such as spatial multiplexing or time multiplexing. Moreover, the second VLC transceiver 22 can implement multi-channel simultaneous communication in a parallel communication structure through a plurality of the channel units, so as to improve a communication speed.

For example, in another exemplary embodiment, the channel units shown in FIG. 3 respectively have different color lights. For example, the visible light emitters LE and the visible light receiver PD in the channel unit CH(1,1) are suitable for emitting and receiving a blue light, and the visible light emitters LE and the visible light receiver PD in the channel unit CH(1,2) are suitable for emitting and receiving a red light. In this way, the channel units of the VLC chip 221 can enhance the communication bandwidth by using modulation technology such as spatial multiplexing or time multiplexing.

Each of the visible light emitters LE illustrated in FIG. 3 may have large-die (for example, greater than 1 mm²) LEDs. Compared to a micro LED, the large-die LED has a relatively large capacitance. The greater the capacitance is, the slower a response time of the LED is. Therefore, a bandwidth of the second VLC transceiver 22 using the large-die LEDs is about 10 MHz. A method of decreasing the capacitance is to directly decrease a die area of the LED. FIG. 4 is a layout schematic diagram of replacing the large-die LEDs with micro LEDs according to another exemplary embodiment of the disclosure. Each of the visible light emitters LE respectively includes a plurality of micro LEDs LE′. An area of one micro LED LE′ can be 0.1 mm*0.1 mm, though the invention is not limited thereto. Each of the large-die LEDs of the visible light emitter LE in FIG. 3 is replaced by a plurality of the micro LEDs connected in parallel. The micro LEDs are disposed on the substrate in an array. By using the micro LEDs connected in parallel to replace a single large-die LED, a response speed is enhanced, and a communication bandwidth/transfer rate is increased to avoid a shortage of excessively dark light of a single large-die LED.

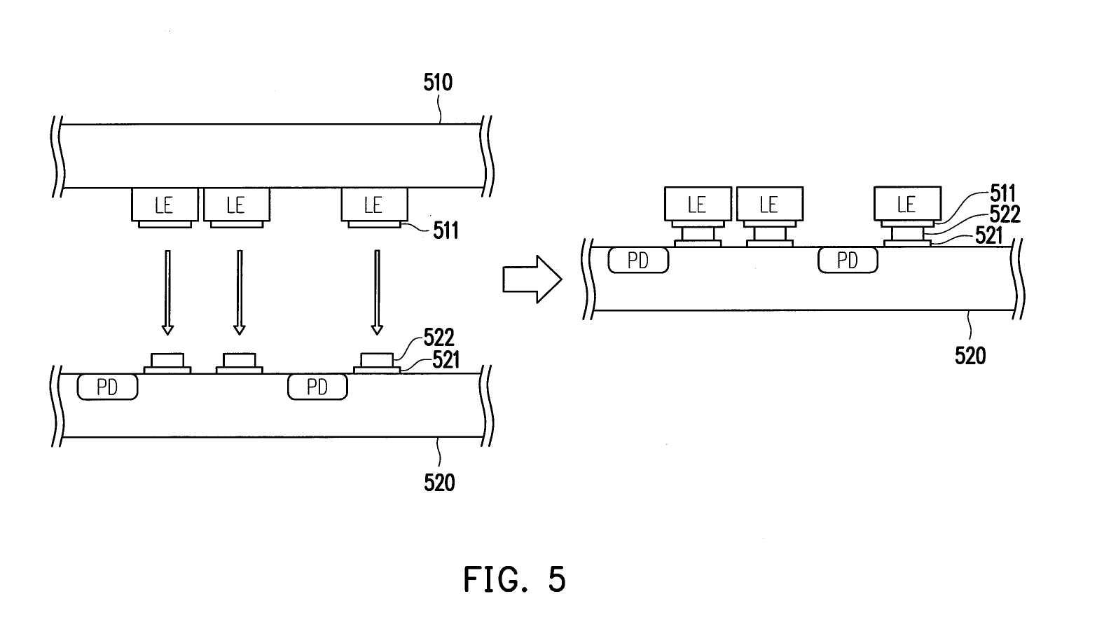

FIG. 5 is a schematic diagram of integrating an upstream channel array and a downstream channel array of the VLC chip 221 into a bi-directional channel array. As shown in a left part of FIG. 5, the visible light emitters LE of the upstream channel array and the visible light receivers PD of the downstream channel array are respectively fabricated on different substrates. For example, the visible light emitters LE are fabricated on an LED substrate 510, where a metal contact layer 511 is configured on each of the visible light emitters LE. The visible light emitters LE can be made of a III-V group material, for example, GaN and GaAs, etc. On the other hand, the visible light receivers PD are fabricated on a control circuit substrate 520. A corresponding conductive bump 522 is configured on the control circuit substrate 520 at a position corresponding to each of the visible light emitters LE, and an under-bump metallization (UBM) layer 521 is disposed between the conductive bump 522 and the control circuit substrate 520. The control circuit substrate 520 can be fabricated according to a silicon-based semiconductor technique. After the upstream channel array and the downstream channel array are fabricated, a wafer bonding method is used to bond the upstream channel array (i.e. LE array) to the control circuit substrate 520 including the downstream channel array (i.e. PD array). After the LED substrate 510 is removed, integration of the upstream channel array and the downstream channel array is completed, which is shown in a cross-sectional view of the bi-directional channel array at a right part of FIG. 5.

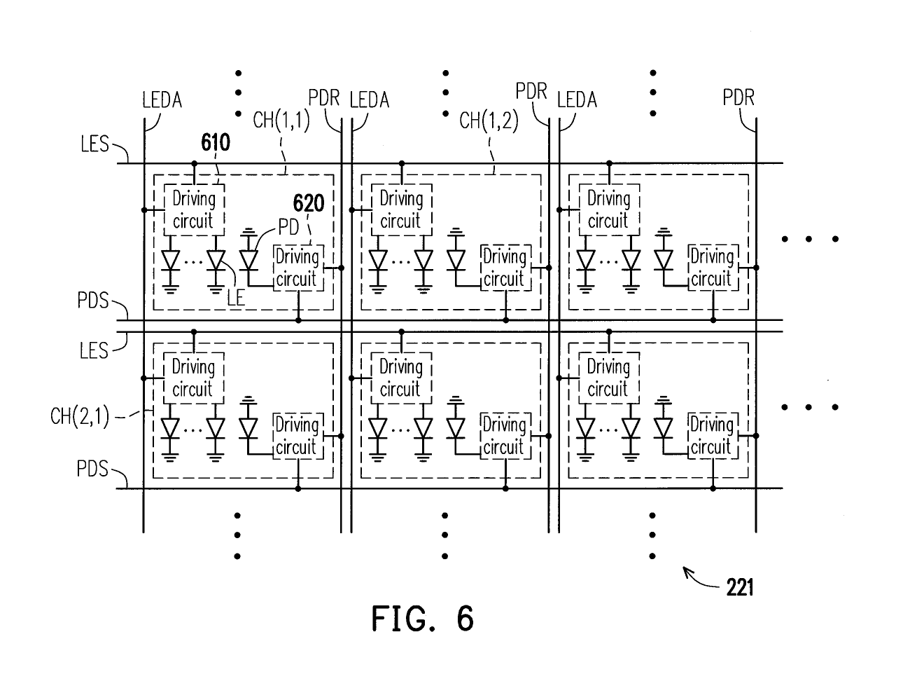

FIG. 6 is a circuit diagram of the bi-directional channel array of the VLC chip 221 of FIG. 3 according to an exemplary embodiment of the disclosure. The VLC chip 221 includes a plurality of light-emitting unit selection lines LES, a plurality of light-emitting unit data lines LEDA, a plurality of light sensing unit selection lines PDS and a plurality of light sensing unit resetting lines PDR. The light-emitting unit selection lines LES and the light sensing unit selection lines PDS are arranged in columns, and the light-emitting unit data lines LEDA and the light sensing unit resetting lines PDR are arranged in rows. Each of the light-emitting unit selection lines LES is electrically connected to driving circuits 610 of the visible light emitters LE of one column in the upstream channel array, and each of the light-emitting unit data lines LEDA is electrically connected to driving circuits 610 of the visible light emitters LE of one row. Each of the driving circuits 610 is electrically connected to a visible light emitter LE of one channel unit. A signal from the light-emitting unit selection line LES determines the driving circuits 610 of a specific column to start driving the visible light emitters LE in the channel units to emit light, and a signal from the light-emitting unit data line LEDA determines a magnitude of a current required for driving the visible light emitters LE of the corresponding row of the channel units. For example, the light-emitting unit selection line LES can control the driving circuit 610 of the channel unit CH(1,1), so that the light-emitting unit data line LEDA can drive the visible light emitter LE of the channel unit CH(1,1) through the driving circuit 610 of the channel unit CH(1,1).

Moreover, the light sensing unit resetting line PDR determines to command driving circuits 620 of a specific row of the channel units to drive the visible light receivers PD to a high voltage level. The reset visible light receivers PD can convert light signals into electric signals. The light sensing unit selection line PDS selects the driving circuits 620 of a specific column of channel units, and reads the electric signal converted by the visible light receiver PD through the selected driving circuit 620.

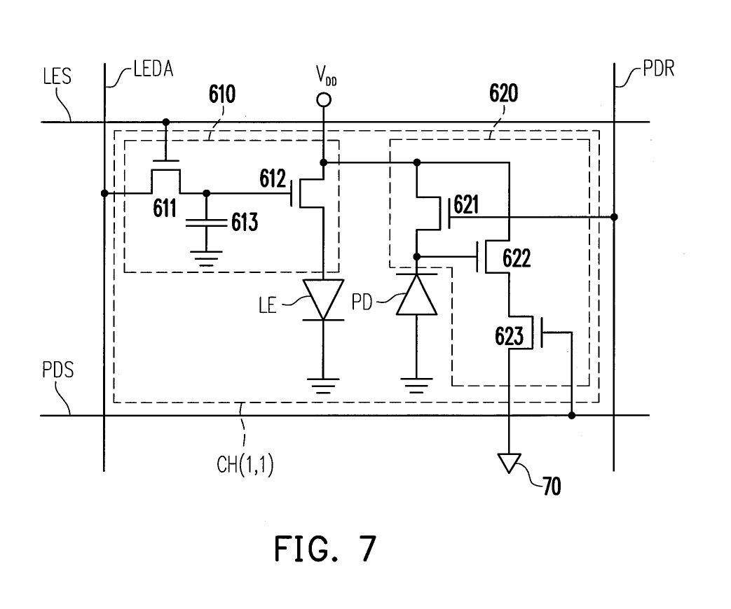

FIG. 7 is a circuit diagram of a channel unit CH(1,1) of FIG. 6 according to an exemplary embodiment of the disclosure. Related descriptions of FIG. 7 can be referred for the other channel units of the VLC chip 221. Referring to FIG. 7, the driving circuit 610 includes a transistor 611, a transistor 612 and a capacitor 613, and the driving circuit 620 includes a transistor 621, a transistor 622 and a transistor 623. When the light-emitting unit selection line LES is in the high voltage level, the transistor 611 is turned on, and now a voltage of the light-emitting unit data line LEDA is input to a gate of the transistor 612 and stored to the capacitor 613. The voltage stored in the capacitor 613 can adjust energy input to the visible light emitter LE in the channel unit CH(1,1) from a voltage source VDD, so as to adjust a light-emitting amount (or light-emitting state) of the visible light emitter LE. When the light-emitting unit selection line LES is in a low voltage level, the transistor 611 is turned off, and the visible light emitter LE maintains its light-emitting amount (or light-emitting state).

On the other hand, when the light sensing unit resetting line PDR is in the high voltage level, the transistor 621 is turned on, and the voltage source VDD is input to a cathode of the visible light receiver PD to form a reverse bias. Now, the transistor 622 is also turned on, and the voltage of the voltage source VDD is input to the transistor 623. When the light sensing unit resetting line PDR is in the high voltage level, if the light sensing unit selection line PDS is also in the high voltage level, a reading terminal 70 reads the electric signal from the voltage source VDD and is in the high voltage level. Then, when the light sensing unit resetting line PDR is transited to the low voltage level and the light sensing unit selection line PDS is still in the high voltage level, the transistor 621 is turned off and the transistor 623 is maintained to be turned on. When the transistor 621 is just turned off, the cathode of the visible light receiver PD is still in the high voltage level, and the reading terminal 70 still reads the voltage from the voltage source VDD. However, during a process that a visible light irradiates the visible light receiver PD, a cathode voltage of the visible light receiver PD gradually decreases. Now, the transistor 622 can be regarded as an amplifier capable of amplifying the cathode voltage of the visible light receiver PD, so that when the cathode voltage of the visible light receiver PD gradually decreases, the voltage read by the reading terminal 70 also gradually decreases. Then, when the light sensing unit selection line PDS is in the low voltage level, the transistor 623 is turned off, and now the voltage at the reading terminal 70 also drops to the low voltage level.

A decreasing speed of the cathode voltage of the visible light receiver PD relates to a brightness of the light irradiating the visible light receiver PD. The larger the intensity of the light detected by the visible light receiver PD is, the larger a photocurrent is, and the faster the cathode voltage decreases, and the faster the voltage of the reading terminal 70 decreases. A controller and/or the communication modulation circuit 21 measures a voltage decreasing speed (for example, an absolute value of a decreasing slope) of the reading terminal 70, or measures the voltage of the reading terminal 70 at a moment before the light sensing unit selection line PDS is switched from the high voltage level to the low voltage level, and converts the intensity of the light detected by the visible light receiver PD into a voltage signal.

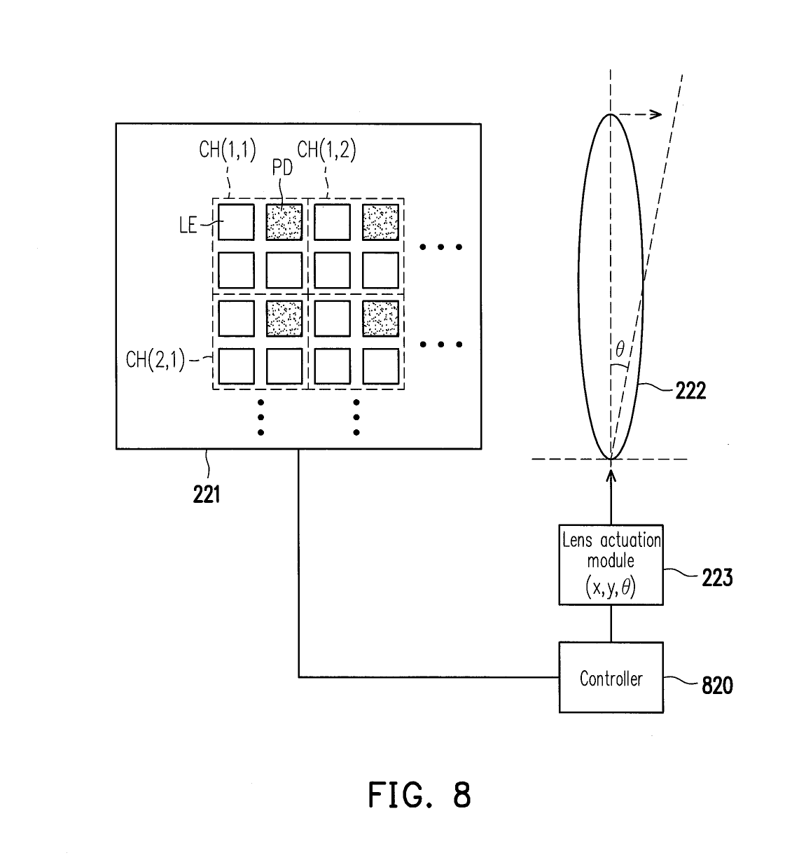

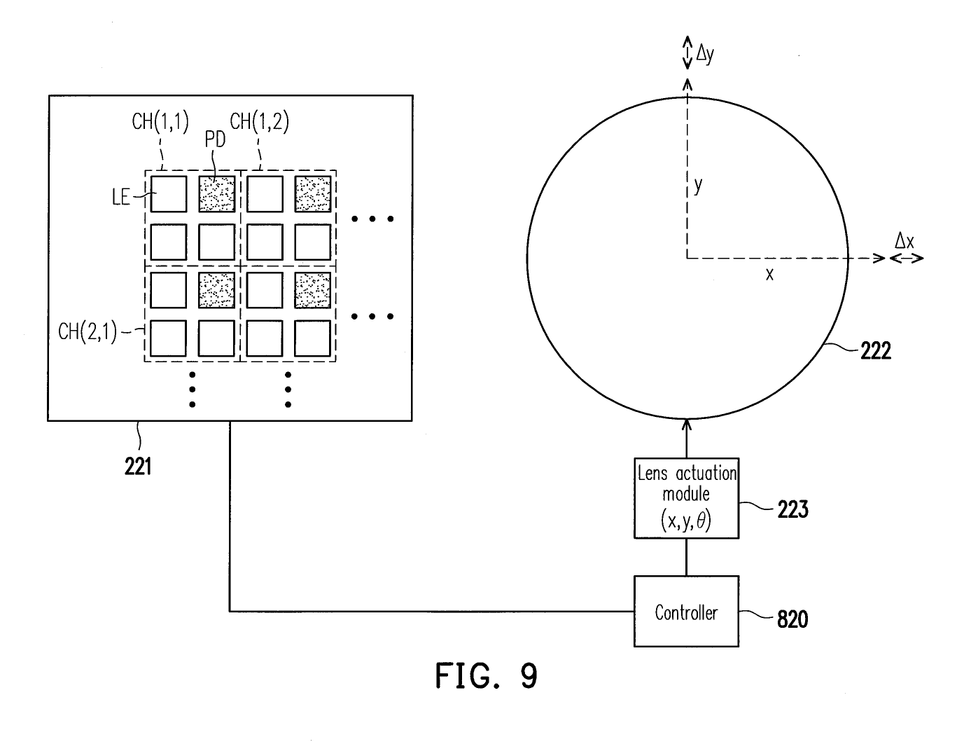

FIG. 8 and FIG. 9 are schematic diagrams of controlling a position and an optical axis direction of the lens module 222 according to an exemplary embodiment of the disclosure. In the present exemplary embodiment, the lens actuation module 223 is controlled by a controller 820. The lens actuation module 223 is coupled to the lens module 222. The lens actuation module 223 includes a servo micro motor and related transmission mechanism for controlling a position, an optical axis direction and/or a focal length of the lens module 222. For example, FIG. 8 is a cross-sectional view of the lens module 222. The lens actuation module 223 can control the optical axis direction of the lens module 222, i.e. a direction angle 0 of the lens module 222. For another example, FIG. 9 is a front view of the lens module 222. The lens actuation module 223 can control the position of the lens module 222, for example, moves the lens module 222 by a distance Ax along an x-axis direction, and/or moves the lens module 222 by a distance Ay along a y-axis direction.

The controller 820 is coupled to the channel units (for example, CH(1,1), CH(1,2) and CH(2,1), etc.) of the VLC chip 221 and the lens actuation module 223. According to receiving situations (for example, a spatial uniformity of an array signal of the visible light receivers PD) of the visible light receivers PD in the channels, the controller 820 controls the lens actuation module 223 to adjust the position, the optical axis direction and/or the focal length of the lens module 222, so that the channel units of the VLC chip 221 obtain maximum transmission/reception signals. Namely, the lens module 222 can actively track a signal intensity of the light receiver array of the VLC chip 221 to improve the signal quality of high-speed multiplexing communication.

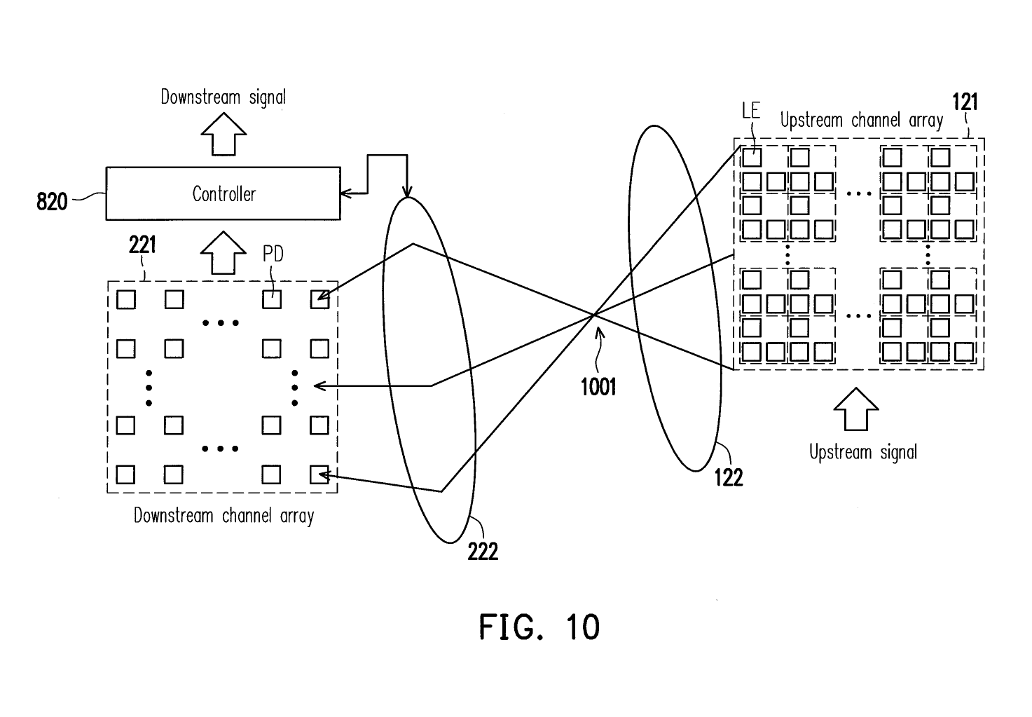

FIG. 10 is an application schematic diagram of the VLC system of FIG. 1 or FIG. 2 actively tracking visible light signals according to still another exemplary embodiment of the disclosure. A free space signal transmission channel is formed between the lens module 122 and the lens module 222 of another transceiving module. The lens module 122 is disposed on an optical path of the upstream channel units of the VLC chip 121. The lens module 222 is disposed on an optical path of the downstream channel units of the VLC chip 221. The lens modules 122 and 222 can actively adjust the focal length and directivity to ensure an optimal light signal quality.

A light signal 1001 of the VLC chip 121 is transmitted to the second electronic device 20 through the lens module 122. The light signal 1001 is transmitted through the lens module 222, and is received by the downstream channel array of the VLC chip 221. The electric signal of the downstream channel array is fed into the controller, and the controller transmits a downstream signal to the communication modulation circuit 21. Moreover, the controller performs an operation similar as that shown in FIG. 8 and FIG. 9 to calculate the spatial uniformity of the array signal of the visible light receivers PD, and provides a control signal to the lens actuation module 223 to adjust the directivity and the focal length of the lens module 222. Moreover, the array signal of the visible light receivers PD can provide a feeding back signal through an autofocus mechanism, so as to control the lens module 222 to perform signal source tracking and optimise a signal strength. Through several times of adjustment, the VLC chip 221 may obtain optimal signal uniformity and optimal signal strength.

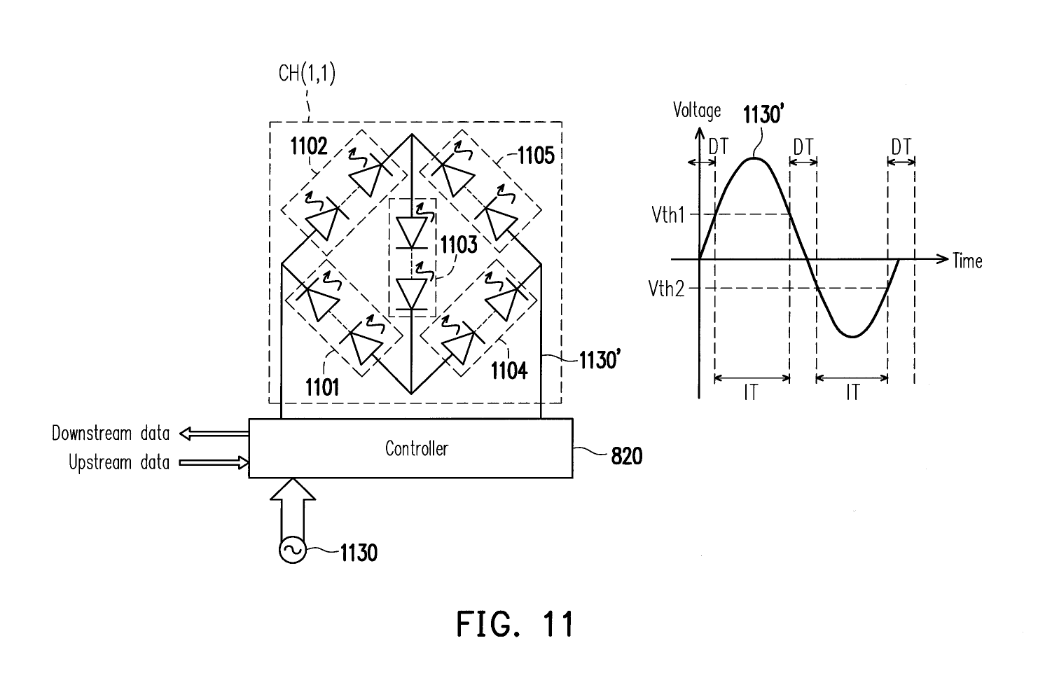

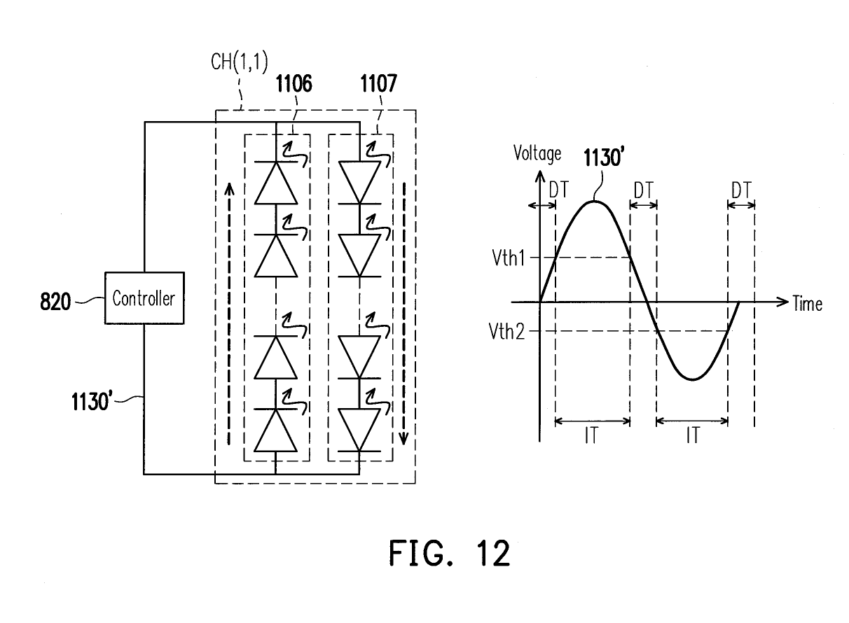

In the aforementioned embodiment, each of the channel units has the visible light emitters LE and the visible light receiver PD, though the disclosure is not limited thereto. For example, FIG. 11 is a circuit diagram of the channel unit CH(1,1) of FIG. 3 according to another exemplary embodiment of the disclosure. Related descriptions of the channel unit CH(1,1) can be referred for the other channel units of the VLC chip 221. Referring to FIG. 11, the channel unit CH(1,1) includes an alternating current light-emitting diode (AC-LED), and the AC-LED includes five direct current light-emitting diodes (DC-LEDs) 1101-1105. Each of the DC-LEDs is composed of one or a plurality of LED connected in series.

A cathode of the DC-LED 1101 and an anode of the DC-LED 1102 are coupled to the controller 820. An anode of the DC-LED 1103 and a cathode of the DC-LED 1105 are coupled to a cathode of the DC-LED 1102. An anode of the DC-LED 1104 and a cathode of the DC-LED 1103 are coupled to an anode of the DC-LED 1101. An anode of the DC-LED 1105 and a cathode of the DC-LED 1104 are coupled to the controller 820. The controller 820 is driven by an AC sine wave power 1130 to output an AC signal 1130′ to drive the LEDs shown in FIG. 11. In the present exemplary embodiment, the sine wave is used to implement the AC signal 1130′, which is shown in a right part of FIG. 11.

When the AC signal 1130′ has a positive voltage, the DC-LEDs 1102, 1103 and 1104 are forward biased, and the DC-LEDs 1101 and 1105 are reverse biased. During such period, only when the AC signal 1130′ is greater than a threshold voltage Vth1 of the DC-LED, the DC-LEDs 1102, 1103 and 1104 emit light, so that a light-emitting period of the DC-LEDs 1102, 1103 and 1104 is referred to as an illumination time slot IT. In the illumination time slot IT, the DC-LEDs 1102, 1103 and 1104 can serve as the visible light emitters LE, and the controller 820 loads upstream data to the AC signal 1130′ in the illumination time slot IT. In the illumination time slot IT, the controller 820 does not extract downstream data of the AC signal 1130′. When the AC signal 1130′ is smaller than the threshold voltage Vth1 of the DC-LED and is greater than 0V, none of the DC-LEDs emit light, and a none light-emitting period of the AC-LED is referred to as a dark time slot DT. In the dark time slot DT and when the AC signal 1130′ is greater than 0V, the reverse biased DC-LEDs 1101 and 1105 can serve as the visible light receivers PD, and the controller 820 can extract the downstream data of the AC signal 1130′ in the dark time slot DT. In the dark time slot DT, the controller 820 does not load the upstream data to the AC signal 1130′.

When the AC signal 1130′ has a negative voltage, the DC-LEDs 1105, 1103 and 1101 are forward biased, and the DC-LEDs 1102 and 1104 are reverse biased. During such period, only when the AC signal 1130′ is smaller than a negative threshold voltage Vth2 of the DC-LED, the DC-LEDs 1105, 1103 and 1101 emit light, so that a light-emitting period of the DC-LEDs 1105, 1103 and 1101 is referred to as the illumination time slot IT. In the illumination time slot IT, the DC-LEDs 1105, 1103 and 1101 can serve as the visible light emitters LE, and the controller 820 loads the upstream data to the AC signal 1130′ in the illumination time slot IT, and does not extract the downstream data of the AC signal 1130′. When the AC signal 1130′ is greater than the negative threshold voltage Vth2 of the DC-LED and is smaller than 0V, none of the DC-LEDs emit light. When the AC-LED is in the dark time slot DT and the AC signal 1130′ is smaller than 0V, the reverse biased DC-LEDs 1102 and 1104 can serve as the visible light receivers PD, and the controller 820 can extract the downstream data of the AC signal 1130′ in the dark time slot DT, and does not load the upstream data to the AC signal 1130′.

In other words, when an amplitude of the AC signal 1130′ approaches to zero, the dark time slot DT is detected through a zero crossing detector of the controller 820, and now the controller 820 stops loading signals to the light source circuit (e.g. the channel unit CH(1,1)), and starts to extract data signals in the light source circuit. According to such feature, in the illumination time slot IT, the AC-LED serves as the visible light emitter LE used for lighting and carrying communication signals, and in the dark time slot DT, the reverse biased LEDs in the AC-LED serve as the visible light receivers PD used for receiving signals. In this way, the same AC-LED device can serve as the visible light emitter LE and the visible light receiver PD by timing, so as to achieve an integrated communication transceiver. Under such structure, the DC-LEDs 1101-1105 can serve as the visible light receivers PD, and semiconductor epitaxial structures thereof can be optimally designed to improve photoelectric conversion efficiency of the light sensors.

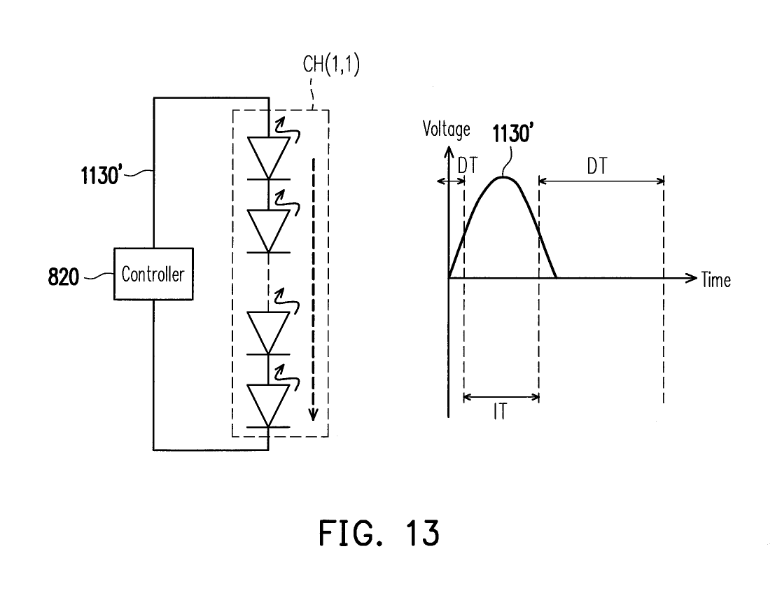

For another example, FIG. 12 is a circuit diagram of the channel unit CH(1,1) of FIG. 3 according to still another exemplary embodiment of the disclosure. Implementation details of the embodiment of FIG. 12 can be deduced according to related descriptions of FIG. 11. Different to the embodiment of FIG. 11, in the embodiment of FIG. 12, the AC-LED is composed of a plurality of DC-LEDs reversely connected in parallel. In the present exemplary embodiment, the AC-LED is composed of DC-LEDs 1106 and 1107, where each of the DC-LEDs is composed of one or a plurality of LEDs connected in series. A first end of the controller 820 is coupled to a cathode of the DC-LED 1106 and an anode of the DC-LED 1107, and a second end of the controller 820 is coupled to an anode of the DC-LED 1106 and a cathode of the DC-LED 1107.

The DC-LEDs 1106 and 1107 alternately emit light under different bias directions. During a period that the AC signal 1130′ output by the controller 820 has the positive voltage to make the DC-LED 1107 bearing a forward bias and the DC-LED 1106 bearing a reverse bias, when the DC-LED 1107 is lighted (in the illumination time slot IT), it can serve as the visible light emitter LE (for lighting and signal communication), and now the controller 820 loads the upstream data to the AC signal 1130′ in the illumination time slot IT. During the period that the AC signal 1130′ has the positive voltage, in the dark time slot DT, the DC-LED 1106 bears the reverse bias to serve as the visible light receiver PD (for receiving the light signal). Conversely, the situation in a period that the AC signal 1130′ output by the controller 820 has the negative voltage to make the DC-LED 1106 bearing a forward bias and the DC-LED 1107 bearing a reverse bias can be deduced by analogy. Therefore, the same AC-LED device can serve as the visible light emitter LE and the visible light receiver PD by timing configuration, so as to achieve the functionality of an integrated communication transceiver.

For another example, FIG. 13 is a circuit diagram of the channel unit CH(1,1) of FIG. 3 according to still another exemplary embodiment of the disclosure. Implementation details of the embodiment of FIG. 13 can be deduced according to related descriptions of FIG. 11. Different to the embodiment of FIG. 11, in the embodiment of FIG. 13, one or a plurality of DC-LEDs is used to form the channel unit CH(1,1) of the VLC chip 221, and each of the DC-LEDs is composed of one or a plurality of LEDs connected in series. For example, FIG. 13 illustrates a single DC-LED, and the DC-LED is composed of a plurality of LEDs connected in series. A first end of the controller 820 is coupled to an anode of the DC-LED, and a second end of the controller 820 is coupled to a cathode of the DC-LED.

The single string of LED (i.e. the DC-LED) shown in FIG. 13 can directly bear a high voltage. In case of the forward bias, the DC-LED of FIG. 13 can be lighted to serve as the visible light emitter LE (for lighting and signal communication), and in case of the reverse bias, the DC-LED of FIG. 13 can serve as the visible light receiver PD (for receiving the light signal). In this way, the same AC-LED device can serve as the visible light emitter LE and the visible light receiver PD by timing configuration, so as to achieve the functionality of an integrated communication transceiver.

In summary, in response to requirements of bandwidth and upload communication technology, the embodiments of the disclosure provide a bi-directional communication and high-speed VLC transceiver, in which an array of the visible light emitters LE and an array of the visible light receivers PD are integrated to form a single light signal transceiver chip, and the lens module focuses and projects the light signal onto the visible light receivers PD. The aforementioned embodiments satisfy demands of high bandwidth (greater than 10 MHz) and bi-directional communication structure (uplink+downlink) in development of VLC technology. In the single transceiver chip, the array of the visible light emitters LE can enhance communication bandwidth by using modulation technology such as spatial multiplexing or time multiplexing. Moreover, if the array of the visible light emitters LE is a multicolor array light source, the multicolor array light source can provide a wavelength multiplexing modulation to increase the communication bandwidth. In the aforementioned embodiment, the lens module capable of actively tracking a signal strength is integrated to ensure signal quality of high-speed multiplexing communication.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A visible light communication transceiver, comprising:
a substrate;
a plurality of channel units, disposed on the substrate in an array, the plurality of channel units respectively providing different bidirectional communication channels, wherein each of the plurality of channel units respectively comprises at least one visible light emitter and at least one visible light receiver; and
a lens module, disposed on an optical path of the plurality of channel units.

2. The visible light communication transceiver as claimed in claim 1, wherein the visible light emitter comprises a light-emitting diode (LED), and the visible light receiver comprises a photodiode or a photon detector.

3. The visible light communication transceiver as claimed in claim 1, wherein each of the plurality of channel units comprises at least one LED, the LED serves as the visible light emitter in an illumination time slot, and the LED serves as the visible light receiver in a dark time slot.

4. The visible light communication transceiver as claimed in claim 3, wherein the LED is an alternating current (AC) LED.

5. The visible light communication transceiver as claimed in claim 4, wherein the AC LED comprises:
a first direct current (DC) LED, having a cathode coupled to a controller;
a second DC LED, having an anode coupled to the cathode of the first DC LED;
a third DC LED, having an anode coupled to a cathode of the second DC LED, and a cathode coupled to an anode of the first DC LED;
a fourth DC LED, having an anode coupled to the anode of the first DC LED, and a cathode coupled to the controller; and
a fifth DC LED, having an anode coupled to the cathode of the fourth DC LED, and a cathode coupled to the cathode of the second DC LED,
wherein during a period when an AC signal outputted from the controller make the second, the third and the fourth DC LEDs bearing a forward bias and make the first and the fifth DC LEDs bearing a reverse bias, the second, the third and the fourth DC LEDs serve as the visible light emitter and the controller loads upstream data to the AC signal in the illumination time slot, and the first and the fifth DC LEDs serve as the visible light receiver and the controller extracts downstream data of the AC signal in the dark time slot.

6. The visible light communication transceiver as claimed in claim 4, wherein the AC LED comprises:
a first DC LED, having a cathode coupled to a first end of a controller, and an anode coupled to a second end of the controller; and
a second DC LED, having an anode coupled to the cathode of the first DC LED, and a cathode coupled to the anode of the first DC LED,
wherein during a period when an AC signal outputted from the controller make the second DC LED bearing a forward bias and make the first DC LED bearing a reverse bias, the second DC LED serves as the visible light emitter and the controller loads upstream data to the AC signal in the illumination time slot, and the first DC LED serves as the visible light receiver and the controller extracts downstream data of the AC signal in the dark time slot.

7. The visible light communication transceiver as claimed in claim 3, further comprising:
a controller, coupled to the LED, and outputting an AC signal to drive the LED,
wherein the controller loads upstream data to the AC signal in the illumination time slot, and extracts downstream data of the AC signal in the dark time slot.

8. The visible light communication transceiver as claimed in claim 1, wherein the visible light emitter comprises a plurality of micro LEDs, and the micro LEDs are arranged on the substrate in an array.

9. The visible light communication transceiver as claimed in claim 1, wherein the channel units respectively correspond to different color lights.

10. The visible light communication transceiver as claimed in claim 1, further comprising:
a lens actuation module, coupled to the lens module; and
a controller, coupled to the channel units and the lens actuation module, wherein the controller controls the lens actuation module to adjust a position, an optical axis direction or a focal length of the lens module according to receiving situations of the visible light receivers.

11. A visible light communication transceiver, comprising:
a downstream channel array, comprising a plurality of downstream channel units configured to respectively provide different downstream channels, wherein each of the plurality of downstream channel units comprises at least one visible light receiver;
a lens module, disposed on an optical path of the downstream channel array;
a lens actuation module, coupled to the lens module; and
a controller, coupled to the downstream channel units and the lens actuation module, and controlling the lens actuation module to adjust a position, an optical axis direction or a focal length of the lens module according to receiving situations of the visible light receivers.

12. The visible light communication transceiver as claimed in claim 11, wherein the visible light receiver comprises a photodiode or a photon detector.

13. The visible light communication transceiver as claimed in claim 11, wherein the downstream channel units respectively receive different color lights.

14. The visible light communication transceiver as claimed in claim 11, further comprising:
an upstream channel array, comprising a plurality of upstream channel units configured to respectively provide different upstream channels, wherein each of the plurality of upstream channel units comprises at least one visible light emitter,
wherein an optical path of the upstream channel units passes through the lens module to reach external of the visible light communication transceiver.

15. The visible light communication transceiver as claimed in claim 14, wherein the visible light emitter comprises an LED.

16. The visible light communication transceiver as claimed in claim 14, wherein the visible light emitter comprises a plurality of micro LEDs arranged in an array.

17. The visible light communication transceiver as claimed in claim 14, wherein the visible light emitters respectively correspond to different color lights.

18. A visible light communication system, comprising:
a first visible light communication transceiver, comprising at least one first upstream channel unit, wherein the first upstream channel unit comprises at least one visible light emitter; and
a second visible light communication transceiver, comprising a downstream channel array, a lens module, a lens actuation module and a controller, wherein the downstream channel array comprises a plurality of downstream channel units configured to respectively provide different downstream channels, and each of the plurality of downstream channel units comprises at least one visible light receiver; at least one of the plurality of downstream channel units receives a visible light emitted by the first visible light communication transceiver; the lens module is disposed on an optical path of the downstream channel units; the lens actuation module is coupled to the lens module; the controller is coupled to the plurality of downstream channel units and the lens actuation module; and the controller controls the lens actuation module to adjust a position, an optical axis direction or a focal length of the lens module according to receiving situations of the visible light receivers.

19. The visible light communication system as claimed in claim 18, wherein the at least one visible light emitter comprises an LED, and the at least one visible light receiver comprises a photodiode or a photon detector.

20. The visible light communication system as claimed in claim 18, wherein the at least one visible light emitter comprises a plurality of micro LEDs arranged in an array.

21. The visible light communication system as claimed in claim 18, wherein the second visible light communication transceiver further comprises:
an upstream channel array, comprising a plurality of second upstream channel units, wherein each of the plurality of second upstream channel units comprises at least one visible light emitter,
wherein the lens module is disposed on an optical path of the plurality of second upstream channel units.
